(19) United States
(12) Patent Application Publication
(10) Pub. No.: US 2007/0180000 A1
(43) Pub. Date: Aug. 2, 2007

(54) Storage apparatus and storage system

(76) Inventors: Hiroshi Mine, Yokohama (JP); Daisuke Yokota, Kawasaki (JP); Shinji Kimura, Sagamihara (JP); Yasunori Kaneda, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/373,163

(22) Filed: Mar. 13, 2006

(30) Foreign Application Priority Data
Jan. 30, 2006 (JP) 2006-020367

(51) Int. Cl. G06F 17/30

(52) U.S. Cl. 707/204

(57) ABSTRACT

In a storage apparatus recording the writing operation of data as journal information, it was necessary to fully overwrite the data to be newly written over the previously written data in order to reduce the journal information. Further, when journal information is reduced, it was not possible to perform accurate recovery in incremental steps. Journal information is separated into journal data information in block units, and journal log information including map information for referring to such journal data information, and this is stored in a journal storage area. When there is journal log information in which block contents of the journal data information coincide, the map information of the new journal log information is rewritten to refer to a block in which the contents to be referred to by the map information of the old journal log information coincide. Journal information can be reduced by reducing redundant journal data information in block units without losing the operational contents representing the journal log information.

### CROSS-REFERENCES TO RELATED APPLICATIONS

This application relates to and claims priority from Japanese Patent Application No. 2006-020367, filed on Jan. 30, 2006, the entire disclosure of which is incorporated herein by reference.

### BACKGROUND

The present invention generally relates to a storage apparatus and storage system, and in particular relates to a storage apparatus and storage system storing differential information on a data volume in a journal volume.

As technology for preventing the loss of information to be stored in a database in a database system, journaling is generally used. Journaling is technology of recording contents of updating operations performed to a database as journal information in an area separate from the database and, when a failure occurs in the database, committing the journal information after the acquisition of backup to the previously acquired backup of the database to enable the restoration of the database. In other words, journal information is differential information.

As technology for performing high-speed backup and restoration processing in a data storage system, differential backup is used. In differential backup, the overall data is initially backed up, and then the differential information is backed up. When a failure occurs in the database, high-speed restoration is enabled by committing the differential information to the overall backup data. Differential backup is an application of journaling to the data storage system.

For example, Japanese Patent Laid-Open Publication No. 2005-18738 discloses technology for preventing the loss of data stored in a storage apparatus by applying journaling to a data storage system.

Further, Japanese Patent Laid-Open Publication No. 2005-222110 discloses technology for alleviating the load of a storage apparatus by using differential information upon restoring data to be stored in a storage apparatus in a separate storage apparatus installed in a remote location in preparation for the occurrence of a failure in the data storage system caused by disaster or the like.

Moreover, Japanese Patent Laid-Open Publication No. 2002-132561 discloses technology enabling restoration processing in a short period of time by reducing journal information as a result of reducing past differential information in a case where new differential information negating operations by past differential information is to be added to a data storage system.

### SUMMARY

As described in the foregoing conventional technologies, it was necessary for the new differential information to negate the previous differential information in order to reduce differential information. Therefore, in a storage apparatus recording the writing operations of data as journal information, data to be newly written must be overwritten on the previously written data in order to reduce journal information. If the data is not completely overwritten; in other words, even if a part of data is not overwritten, it is not possible to reduce journal information. Nevertheless, since the past differential information would be reduced as a result of performing the processing for reducing the differential information, when attempting to restore data at an arbitrary time in the past where differential information was recorded by selectively committing the differential information, with conventional technology, it is not possible to restore the data image from the deleted past differential information to the differential information at a new arbitrary time. Therefore, when aiming to perform recovery in incremental steps of sequentially committing the journal information from [past data] to the data stored in the storage device in accordance with the designation or the like of the administrator for recovering from a software failure, with conventional technology, it was not possible to restore, in incremental steps, the status of the stored data during the period the journal information is deleted until such journal information is overwritten.

In order to overcome the foregoing problems, an object of the present invention is to provide a storage apparatus capable of recovering the status of stored data at an arbitrary time after the recording of journal log information has been commenced while reducing differential data information. Moreover, another object of the present invention is to provide a remote copy system including a plurality of storage apparatuses capable of reducing the amount of information to be transmitted during the remote copy by eliminating the redundant data blocks from the journal information transmitted between the storage apparatuses.

In order to achieve the foregoing objects, the present invention separates journal information into journal log information and journal data information, and distinctively manages such information. In other words, one aspect of the present invention provides a storage apparatus having a storage device, and a controller for controlling a data write request from a computer device to the storage device, wherein the storage device includes a primary data storage area, and a journal storage area storing differential information of the primary data storage area as journal information; and wherein the journal storage area is configured by including a storage area of journal log information of the journal information, and a storage area of journal data information of the journal information.

Another aspect of the present invention provides a storage apparatus having a storage device, and a controller for controlling a data write request from a computer device to the storage device, wherein the controller manages journal information, which is differential information of a primary data storage area, by separating it into journal log information and journal data information, and shares the same journal data information between a plurality of journal logs.

Moreover, a further aspect of the present invention provides a storage apparatus connected to a host system, having: a data volume; a control unit; and a journal volume including an area storing a log of the data volume, and a block list prescribing the correspondence of a block number of an area storing differential data of the data volume and an area storing the differential data and the log information, wherein, upon receiving a write request from the host system, the control unit writes the write request in the journal volume, and, when the logs of the written write request become a plurality of logs, examines the status of the new differential data containing a portion coinciding with the contents of the oldest differential data based on differential data corresponding to the oldest log among the logs, changes the correspondence of a redundant block number to a block number corresponding to the oldest log, and releases a block of the area storing the differential data corresponding to the redundant block number.

Moreover, yet another aspect of the present invention provides a storage system-having the foregoing storage apparatus as a first storage apparatus, and a second storage apparatus connected to the first storage apparatus via a communication path, and which seeks the synchronization of the data content stored in both storage apparatuses by transmitting journal information from the first storage apparatus to the second storage apparatus via the communication path, wherein the first storage apparatus omits the data block containing redundant contents from the journal data information sequence by not including a block number overlapping with information of the block number upon transmitting the journal information to the second storage apparatus as the journal log information sequence, block number information sequence referred to with the foregoing map, and the journal data information sequence.

According to the present invention, journal information, which is differential information of a primary data storage area, is separated into journal log information and journal data information and the same journal data information is shared between a plurality of journal logs, and it is thereby possible to compress the journal information.

As explained above, according to the present invention, it is possible to provide a storage apparatus capable of recovering (step recovery) the status of stored data at an arbitrary time after the recording of journal log information has been commenced while reducing differential data information. Moreover, according to the present invention, it is possible to provide a remote copy system including a plurality of storage apparatuses capable of reducing the amount of information to be transmitted during the remote copy by eliminating the redundant data blocks from the journal information transmitted between the storage apparatuses.

### DESCRIPTION OF DRAWINGS

FIG. 1 is a block diagram showing the configuration of the storage apparatus pertaining to the first embodiment of the present invention;

FIG. 2 is a block diagram showing the configuration of the controller of the storage apparatus;

FIG. 3 is a block diagram showing the configuration of the journal storage area of the storage apparatus;

FIG. 4 is a block diagram showing a situation where journal information is being stored in the journal storage area;

FIG. 5 is a flowchart showing the routine for adding journal information to the storage apparatus;

FIG. 6 is a flowchart showing the routine for reducing journal information from the storage apparatus;

FIG. 7 is a flowchart showing the routine for committing journal information to the storage apparatus;

FIG. 8 is a flowchart showing the routine for abandoning journal information in the storage apparatus;

FIG. 9 is a block diagram of the remote copy system enabling the reduction of journal information; and

FIG. 10 is a data image of journal information to be transmitted between storage apparatuses via a network.

### DETAILED DESCRIPTION

Embodiments of the present invention are now explained with reference to the drawings.

### First Embodiment

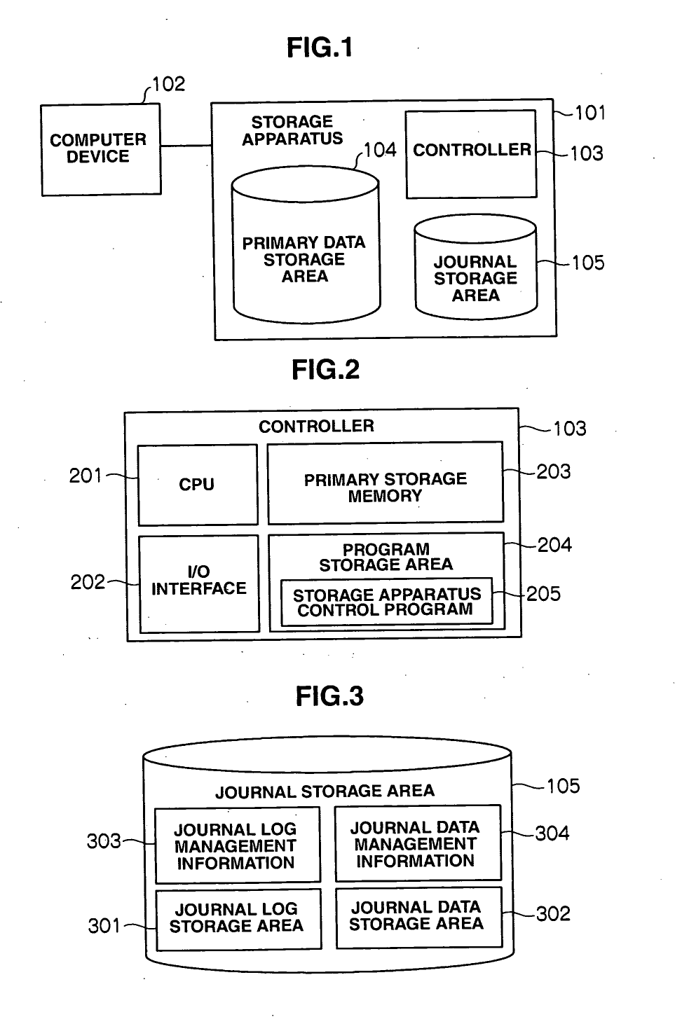

FIG. 1 is a functional block diagram-of a storage apparatus showing the first embodiment of the storage apparatus pertaining to the present invention. The storage apparatus 101 is connected to a computer device 102 as a host system via a SAN (Storage Area Network) or the like, and receives and processes a data read request, data write request and so on issued from the computer device 102. The storage apparatus 101 has a controller 103, a primary data storage area (data volume) 104 and a journal storage area (journal volume) 105. The controller (control unit) 103 controls the overall storage apparatus 101. The controller 103 processes the read request, write request and soon issued from the computer device 102 to the storage device. The primary data storage area 104 and journal storage area 105 are configured from a hard disk device, nonvolatile memory or the like. When journaling is not performed, data to be written from the computer device 102 is directly stored in the primary data storage area 104. When journaling is to be performed, after the start of journaling, new data is stored as journal information in the journal storage area 105. In this case, a snapshot at the start of journaling is stored in the primary data storage area 104, and differential data of the primary data storage area 104 after the start of journaling is stored in the journal storage area 105.

The journal information stored in the journal storage area 105 is committed to the primary data storage area 104 by the controller 103 according to instructions of the administrator. Data read by the computer device 102 during the execution of journaling is configured by the controller 103 based on data stored in the primary data storage area 104 and journal storage area 105.

FIG. 2 shows the configuration of the controller 103 of the present embodiment. The controller 103 is configured from a CPU (Central Processing Unit) 201, an I/O (Input/Output) interface 202, a primary storage memory 203 such as a RAM (Random Access Memory) and a program storage area 204 such as a ROM (Read Only Memory). The controller 103 controls the overall storage apparatus 101 by reading a storage apparatus control program 205 stored in the program storage area 204 into the primary storage memory 203, and executing this program on the CPU 201. The controller 103 performs the communication with the computer device 102 and access to the primary data storage area 104 and journal storage area 105 via the I/O interface 202.

FIG. 3 shows the configuration of the journal storage area 105. The journal storage area 105 is configured from a journal log storage area 301, a journal data storage area 302, journal log management information 303 and journal data management information 304. The journal log storage area 301 is an area for storing the journal log information described later as a ring buffer. The journal log storage area 301 is managed by the journal log management information 303. The journal log management information 303 is formed from the overall size of the journal log storage area 301, a pointer showing the top of the in-use area in the journal log storage area, and the length showing the size of the in-use area, and is used for managing the in-use area and unused area of the journal log storage area. Here, the unused area is defined as an area starting from a position of adding the length showing the size of the in-use area to the pointer showing the top of the in-use area, and having a size obtained by subtracting the length showing the in-use area from the overall size.

The journal data storage area 302 is an area for storing the journal data information described later in block units such as disk sector units, and is managed by the journal data management information 304. The journal data management information 304 has information of sequences storing the reference count corresponding one-on-one to each block regarding the journal data area 302, and the controller 103 manages the in-use and unused blocks of the journal data storage area with this management information. The reference count is a nonnegative integer, and an in-use block is defined as a block having a reference count that is not zero, and an unused block is defined as a block having a reference count of zero, respectively.

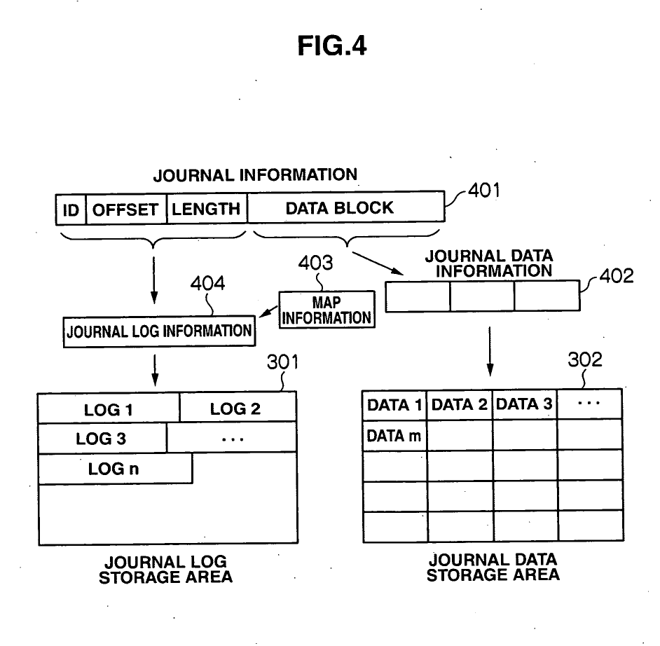

FIG. 4 is a block diagram showing the state where journal information is being stored in the journal storage area 105. The journal information 401 corresponds to a write request from the computer device 102 to the storage apparatus 101, and is configured from a time that the controller 103 receives a request as an ID for uniquely identifying journal information, a sector number of the primary data storage area 104 as an offset showing the position of writing data in the primary data storage area 104, number of sectors of data as the length showing the length of data to be written in the primary data storage area, and a variable data block storing the contents of data to be written.

Among the information contained in the journal information 401, a data block is divided into blocks in sector units, and the divided data block is stored as the journal data information 402 by being separated into a plurality of unused blocks of the journal storage area 302. Here, the journal data information 402 does not necessarily have to be stored in consecutive blocks of the journal storage area 302. The address in which the journal data information 402 is stored in the journal storage area 302 is stored in the journal log storage area 301 as a block list (map information 403) formed from the alignment of the block numbers of the journal storage area 302. The map information 403 is stored in the journal log storage area 301 as a part of the variable journal log information 404 together with information (ID, offset, length) excluding the data block from the journal information 401.

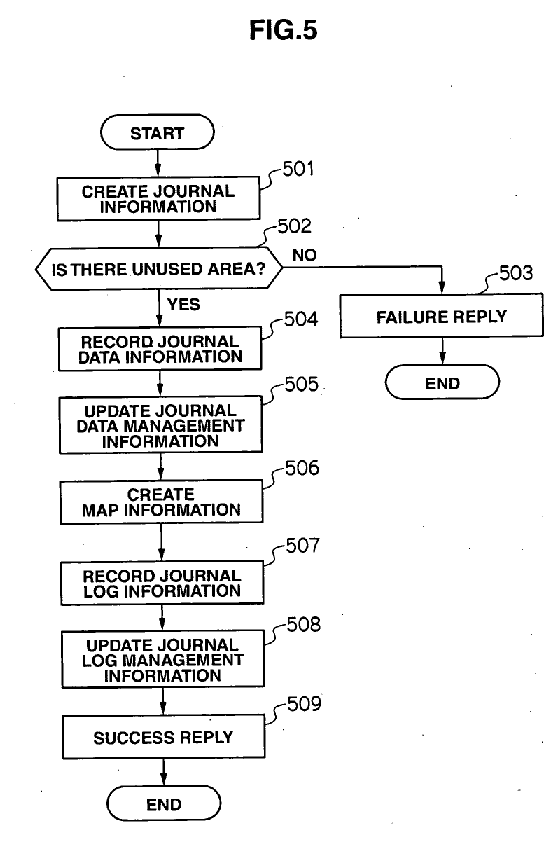

FIG. 5 is a flowchart showing the routine for adding the journal information to the storage apparatus. The storage apparatus 101 receives a write request from the computer device 102 with the controller 103, and creates journal information 401 (step 501). The controller 103 determines whether the journal storage area 105 has an unused area capable of storing the created journal information 401 (step 502). Specifically, the [controller 103] estimates the size of the journal log information 104 based on length information; that is, the required number of blocks, refers to the journal log management information 303 to determine whether the journal log storage area 301 has an unused area of a required size, and refers to the journal data management information 304 to determine whether the journal data storage area 302 has a required number of unused blocks.

When the journal storage area 105 does not have an unused area capable of storing the journal information 401, the [controller 103] returns a reply indicating the failure of the write request to the computer device 102 (step 503), and ends the processing. When the [journal storage area 105] has an unused area capable of storing the journal information 401, the [controller 103] refers to the journal data management information 304, and divides the journal data information 402 into block units and stores these in a block of the journal data storage area 302 corresponding to an unused block; that is, a block having a reference count of zero (step 504).

Next, the [controller 103] updates the journal data management information 304, and increments the reference count by 1; that is, changes zero to 1 regarding the reference count corresponding to the block newly storing the data (step 505). Next, the [controller 103] creates map information 403 as the arrangement of the block number of the block newly storing the data and the address of the journal data storage area (step 506). The map information configures the journal log information 404 together with information excluding the data block of the journal information 401, and the controller 103 refers to the journal log management information 303, and stores the new journal log information in an unused area of the journal log storage area 301; that is, at a position indicated by a value obtained by adding the length showing the size of in-use area to the pointer showing the top of the in-use area of the journal log management information 303 (step 507).

Next, the controller 103 updates the journal log management information 303, and changes the length showing the size of in-use area to a length added with the size of the current journal log information 404 (step 508). Finally, the [controller 103] returns a reply indicating the success of the write request to the computer device 102 (step 509), and ends the processing.

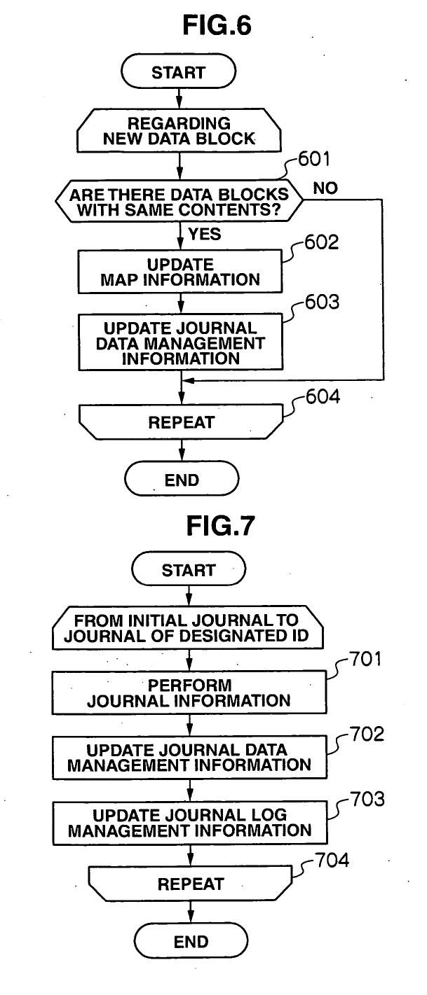

FIG. 6 shows a routine for reducing the journal information 401. The controller 103 of the storage apparatus 101 stores the new journal information 401 in the journal storage area 105 as the journal data information 402 and journal log information 404, and thereafter determines whether the contents of the respective blocks of the journal data information 402 newly added to be referred to by the map information 403 and the respective blocks of the old journal data information to be referred to by the map information of the old journal log information coincide ([step] 601). Here, the determination on whether the contents of the blocks coincide can be conducted by determining whether the bit sequence stored in both blocks fully coincide. Nevertheless, for example, if CRC (Cyclic Redundancy Check) information or the like is added per block in order to correct errors, these can be foremost compared in order to omit the comparison of the bit sequence in the case when the contents of blocks do not coincide.

When there are no blocks having coinciding contents, the controller 103 repeats the foregoing comparison processing regarding the next new block to be referred to by the map information 403. When there are blocks having coinciding contents, the [controller 103] updates the map information 403, and replaces the block number to refer to the block of the old journal data information (step 602). Next, the [controller 103] updates the journal data management information 304, reduces the reference count of the block referred to before the change of the map information 403 by 1, and increments the reference-count of the block to be referred to after the change of the [map information 403] by 1 (step 603). Here, the block having a reference count of zero can be used as an unused capacity, and-the area in the journal storage area 105 occupied by the journal information 401 can be reduced in an amount of the block that became an unused capacity.

The controller 103 may update the block list (map information) at a designated time, when a transaction is not sent from the computer device to the controller, or when journal information is accumulated in an arbitrary amount, and there is no particular limitation.

The foregoing routine is repeated regarding the new block to be referred to by the map information 403 (step 604), and the processing is ended once the comparison of all new blocks is complete.

FIG. 7 shows the routine of committing the journal information to the primary data storage area 104. Commitment of journal information is conducted according to instructions from the administrator. For example, the administrator instructs the commitment of journal information up to a certain time by designating such time. The controller 103 of the storage apparatus 101 receives instructions from the administrator, and updates the primary data storage area 104 with the journal information up to a time designated from the oldest journal information 401 stored in the journal storage area 105. The oldest journal information 401 is represented with the oldest journal log information 404 stored in the journal log storage area 301 designated by the pointer showing the top of the in-use area of the journal log management information 303, and the journal data information 402 stored in the journal data storage area 302 referred to by the map information 403.

Commitment of the journal information 401 to the primary data storage area 104 is conducted by the controller 103 writing the contents of the journal data information 402 referred to by the map information 403 in a position of the primary data storage area 104 shown with the journal log information 404 (step 701). Next, the controller 103 updates the journal data management information 304; in other words, reduces the reference count of each block that was referred to by the map information 403 by 1 (step 702). Here, a block having a reference count of zero will become unused and released, but a block having a reference count that is not zero; that is, a block being referred to by the map information of the journal log information will not be released since it is still an in-use block.

Next, the [controller 103] updates the journal log management information 302; in other words, changes the pointer showing the top of the in-use area in the journal log storage area 301 to a pointer added with the size of the journal log information 404, and changes the length showing the size of the in-use area to a length in which the size of the journal log information 404 is deducted (step 703). Thereby, the area in the journal log storage area 301 occupied by the journal log information 404 will become unused and released. The foregoing routine is repeated regarding newer journal information (step 704), and the processing is ended when there is no more journal information that is older than the designated time.

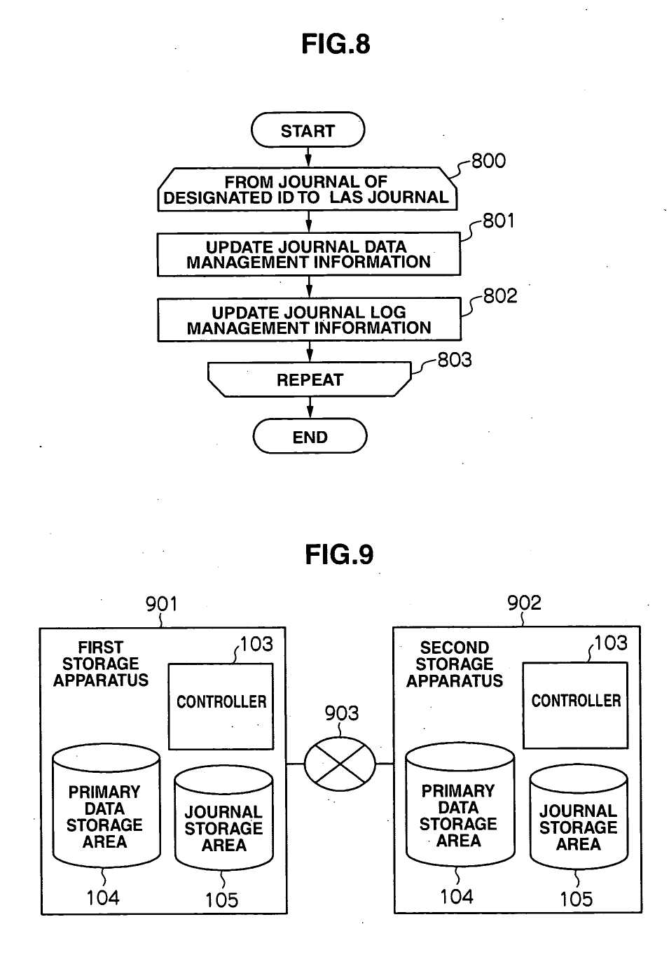

FIG. 8 shows a routine for canceling the journaling operation; that is, abandoning the journal information. Cancellation of the journaling operation is conducted according to instructions from the administrator as with the commitment of journal information, and is for abandoning journal information from the designated time onward. The controller 103 of the storage apparatus 101 receives instructions from the administrator, refers to the journal log management information 303, and specifies the journal log information 404 having an ID from the designated time onward by tracking back the journal log information in order from the oldest journal log information (step 800). The journal information 401 to be abandoned is defined by the journal log information 404, and the journal data information 402 referred to by the map information 403. Abandonment of the journal information 401 is performed by the controller 103 foremost updating the journal data management information 304, and reducing the reference count of the respective blocks referred to by the map information 403 by 1 (step 801).

Next, the [controller 103] updates the journal log management information 302, and changes the length showing the size of the in-use area to a length in which the size of the journal log information 404 is deducted (step 802). The foregoing routine is repeated regarding new journal information (step 803), and the processing is ended when there is no more journal information that is new at the designated time.

As explained above, with this storage apparatus, in addition to a case of completely overwriting data by dividing the data block contained in the journal information into blocks in sector units and comparing the contents in block units, even in cases of partially overwriting data, it is possible to reduce journal information. Further, information to be reduced upon the reduction of journal information is a redundant data block, and information contained in the journal information will remain in a fully reproducible state. Thus, even when the journal information is reduced, it is possible to recover, in incremental steps, the journal information to a status at an arbitrary time after the start of recording of such journal information.

### Second Embodiment

FIG. 9 shows a storage apparatus as the second embodiment of the present invention. The same reference numerals are given to the components that are the same as those used in the first embodiment, and the explanation thereof is omitted. A first storage apparatus 901 and a second storage apparatus 902 are connected via a network 903 such as the Internet. The second storage apparatus 902 is used as a backup system for retaining the same contents as the first storage apparatus 902. As the initial state, for example, methods such as backup and restoration with a magnetic tape are used to synchronize the data content of the first storage apparatus 901 and the second storage apparatus 902. Thereafter, in order to synchronize the data content of the first storage apparatus 901 and second storage apparatus 902, the content of the writing operation in the first storage apparatus 901 is transferred to the second storage apparatus 902 via the network 903, and writing is executed with the second storage apparatus. Here, as the content of the writing operation to be transmitted via the network 903, differential information of the synchronized primary data storage area 104; that is, the journal information 401 stored in the journal storage area 105 is used.

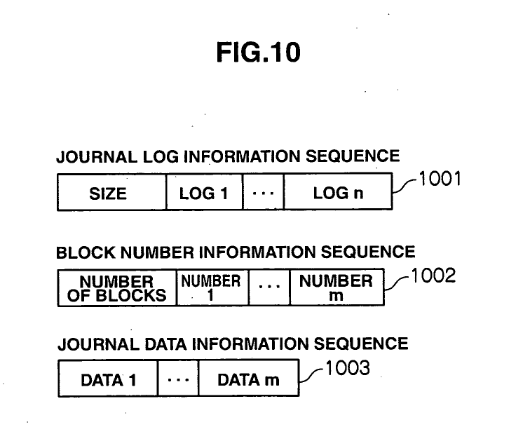

FIG. 10 represents the data configuration of the journal information to be transmitted via the network. The journal information stored in the journal storage area 105 is transmitted as a journal log information sequence 1001, a block number information sequence 1002, or a journal data information sequence 1003 via the network 903 by consolidating one or more types of journal information periodically or according to instructions from the administrator. The journal log information sequence 1001 is a result of adding its size to the one or more types of journal log information to be transferred and which is stored in the journal log storage area 301.

The block number information sequence 1002 is a result of adding its number; that is, the number of blocks to be transferred to the block number sequence of the journal data storage area 302 storing the journal data information 402 to be referred to by the map information of the transferred journal log information. The journal data information sequence 1003 is a result of arranging the contents of the block of the journal data storage area 302 shown with the block number information sequence 1002 in the order of the block number information sequence 1002, and the number thereof coincides with the number of blocks of the block number information sequence 1002.

Here, the journal data information to be referred to by the map information of the transmitted plurality of types of journal log information only needs to be transmitted once, and, by not including the redundant block number upon creating the block number information sequence 1002, it is possible to prevent over-transmitting blocks with redundant data content. Therefore, the number of blocks of the block number information sequence 1002 is less in the amount of redundant blocks in comparison to the total size of map information of the journal log information contained in the journal log information sequence 1001. Incidentally, when the configuration of the journal storage area is different among the storage apparatuses, the map information of the journal log information sequence 1001 and block number contained in the block number information sequence 1002 on the receiving side do not show the absolute position in the journal data storage area, and these may be handled as tags for differentiating the individual blocks.

As explained above, the storage apparatus of the present embodiment is able to reduce the amount of information to be transmitted to a network when performing remote copying by removing redundant data blocks from the journal information to be transmitted to the network.

The embodiments described above are merely examples, and the present invention shall not be limited in any way by such embodiments.

We claim:

1. A storage apparatus comprising a storage device, and a controller for controlling a data write request from a computer device to said storage device,
wherein said storage device includes a primary data storage area, and a journal storage area storing differential information of said primary data storage area as journal information; and
wherein said journal storage area is configured by including a storage area of journal log information of said journal information, and a storage area of journal data information of said journal information.

2. The storage apparatus according to claim 1, wherein said controller, upon storing a write request from said computer device as said journal information in a journal storage area, separates said journal information into journal log information and journal data information, and stores said journal log information in said journal log storage area, and stores said journal data information in said journal data storage area.

3. The storage apparatus according to claim 2, wherein said journal data information is divided into fixed length units and stored in said journal data storage area, and map information, which shows the block among the plurality of blocks in said journal data storage area storing the unit of each of said divided journal data information, is stored in said journal log storage area.

4. The storage apparatus according to claim 3, wherein said journal data storage area is divided into fixed length block units, and the sequence formed from a reference count of said controller referring to said block regarding each of said block units is stored as journal data management information in said journal storage area.

5. The storage apparatus according to claim 4, wherein said controller refers to said journal data management information, stores said journal data information in said block in which said reference count is zero, updates said journal data management information, and increments the reference count corresponding to the block storing said journal data information by 1.

6. The storage apparatus according to claim 5, wherein said controller adds said map information to said journal information excluding said journal data information, and stores this as said journal log information in an unused capacity of said journal log storage area, and, after storing said journal log information, updates the length showing the size of area being used in said journal log storage area among the journal log management information to a length to which the size of the journal log information was added.

7. The storage apparatus according to claim 4, wherein said controller compares new journal information and existing journal information previously stored in said journal storage area, and, when said block with redundant contents exists in said journal data storage area, changes said map information of the journal log information of said new journal information so as to refer to a block in which the contents of said existing journal information coincide.

8. The storage apparatus according to claim 4, wherein said controller compares new journal information and existing journal information previously stored in said journal storage area, and, when said block with redundant contents exists in said journal data storage area, changes said map information of the journal log information of said existing journal information so as to refer to a block in which the contents of said new journal information coincide.

9. The storage apparatus according to claim 7 or claim 8, wherein said controller updates said journal data management information, reduces the reference count of said block referred to by said map information before the change by 1, and increments the reference count of said block referred to by said map information after the change by 1.

10. The storage apparatus according to claim 9, wherein said controller releases said block in which said reference count became 0 as a storage area of said journal data information of said new journal information.

11. The storage apparatus according to claim 3, wherein, when said controller commits said journal information in said primary data storage area, it updates said journal data management information, reduces said reference count corresponding to all of said blocks referred to by said map information one at a time, and changes the size of said journal log information to a size obtained by subtracting the size of said journal information committed in said primary data storage area.

12. The storage apparatus according to claim 11, wherein said controller commits said journal data information of said block referred to by said map information in an address of said primary data storage area designated with said journal log information.

13. The storage apparatus according to claim 3, wherein said controller reduces said reference count corresponding to all of said blocks referred to by said map information of said journal information to be abandoned, whereby said journal information from the selected time onward is configured to be abandoned, one at a time.

14. A storage apparatus comprising a storage device, and a controller for controlling a data write request from a computer device to said storage device, wherein said controller manages journal information, which is differential information of a primary data storage area, by separating it into journal log information and journal data information, and shares the same journal data information between a plurality of journal logs.

15. A storage apparatus connected to a host system, comprising:
a data volume;
a control unit; and
a journal volume including an area storing a log of said data volume, and a block list prescribing the correspondence of a block number of an area storing differential data of said data volume and an area storing said differential data and said log information,
wherein, upon receiving a write request from said host system, said control unit writes said write request in said journal volume, and, when the logs of said written write request become a plurality of logs, examines the status of the new differential data containing a portion coinciding with the contents of the oldest differential data based on differential data corresponding to the oldest log among said logs, changes the correspondence of a redundant block number to a block number corresponding to said oldest log, and releases a block of the area storing said differential data corresponding to the redundant block number.

16. The storage apparatus according to claim 15, wherein said control unit associates reference information to said block list, and releases said block based on said reference information.

17. The storage apparatus according to claim 15, wherein said control unit adds reference information to a block of the area storing said differential data referred to via said block list, and releases said block when the reference information becomes a certain value.

18. The storage apparatus according to claim 15, wherein said control unit changes said redundant block number to a block number corresponding to said oldest log at the timing of a designated time, and releases a block of the area storing said differential data corresponding to the redundant block number.

19. The storage apparatus according to claim 15, wherein said control unit changes the correspondence of said redundant block number to a block number corresponding to said oldest log at a timing in which a transaction is not transmitted from said host system, and releases a block of the area storing said differential data corresponding to the redundant block number.

20. A storage system comprising the storage apparatus according to claim 1 as a first storage apparatus, and a second storage apparatus connected to said first storage apparatus via a communication path, and which seeks the synchronization of the data content stored in both storage apparatuses by transmitting journal information from said first storage apparatus to said second storage apparatus via said communication path, wherein said first storage apparatus omits the data block containing redundant contents from said journal data information sequence by not including a block number overlapping with information of said block number upon transmitting said journal information to said second storage apparatus as said journal log information sequence, block number information sequence referred to with the map according to claim 3, and said journal data information sequence.
